(19) United States
(12) Patent Application Publication
(10) Pub. No.: US 2024/0118810 A1
(43) Pub. Date: Apr. 11, 2024

(54) MEMORY SYSTEM AND OPERATING METHOD THEREOF

(71) Applicant: SK hynix Inc., Gyeonggi-do (KR)

(72) Inventors: Moon Hyeok CHOI, Gyeonggi-do (KR); Kwang Ho CHOI, Gyeonggi-do (KR); Nam Hyeok JEONG, Gyeonggi-do (KR); Yong Wan HWANG, Gyeonggi-do (KR)

(21) Appl. No.: 18/107,510

(22) Filed: Feb. 9, 2023

(30) Foreign Application Priority Data
Oct. 11, 2022 (KR) 10-2022-0129285

(51) Int. Cl. G06F 3/06

(52) U.S. Cl. CPC G06F 3/0614; G06F 3/0659; G06F 3/0679

(57) ABSTRACT

A memory system may include: a memory device configured to store first training information and second training information representing different training patterns; and a memory controller configured to: perform a first training operation on the memory device based on the first training information, and perform, when a result of the first training operation is out of a predetermined range, a second training operation on the memory device plural times based on the second training information.

### CROSS-REFERENCE TO RELATED APPLICATION

The present application claims priority under 35 U.S.C. § 119(a) to Korean patent application number 10-2022-0129285, filed on Oct. 11, 2022, the entire disclosure of which is incorporated herein by reference.

### BACKGROUND

### 1. Field of Invention

Various embodiments of the present disclosure relate to a memory system and an operating method thereof.

### 2. Description of Related Art

Semiconductor memories may be classified into volatile memory devices, such as an SRAM or a DRAM, and nonvolatile memory devices, such as a PRAM, an MRAM, an RRAM, or an FRAM. A volatile memory device may lose data stores therein when the supply of power is blocked. A nonvolatile memory device may retain data stored therein even when the supply of power is blocked.

A memory controller and a memory device communicate with each other through data signals. Training may be performed to improve the reliability of data transmission through data signals between the memory controller and the memory device. The training includes aligning transmission or arrival timings of data transmitted in parallel through data signals.

### SUMMARY

Embodiments of the present disclosure provide a memory system with improved reliability and stability, and an operating method thereof.

In accordance with an aspect of the present disclosure, there is provided a memory system including: a memory device configured to store first training information and second training information representing different training patterns; and a memory controller configured to: perform a first training operation on the memory device based on the first training information, and perform, when a result of the first training operation is out of a predetermined range, a second training operation on the memory device plural times based on the second training information.

In accordance with another aspect of the present disclosure, there is provided a memory system including: a memory device configured to store first training information and second training information representing different training patterns; and a memory controller configured to: perform a first training operation on the memory device based on the first training information, perform a verify operation of verifying a result of the first training operation when the result of the first training operation is out of a predetermined range, and perform a second training operation on the memory device based on the first training information or the second training Information according to a result of the verify operation.

In accordance with still another aspect of the present disclosure, there is provided a method of operating a memory system, the method including: performing a first training operation on a memory device based on first training information stored in the memory device; performing a second training operation plural times when a result of the first training operation is out of a predetermined range; and computing a final training value according to the second training operations performed the plural times.

In accordance with still another aspect of the present disclosure, there is provided a method of operating a controller, the method including: performing a first training operation on a memory device with a first training data piece that is predetermined for the memory device with a noise-free level; and performing, when a result of the first training operation is beyond a predetermined range, a second training operation for a predetermined number of times on the memory device with respective second training data pieces, each of which is predetermined for the memory device with a corresponding one of different noise levels, wherein a result of the performing of the second training operation for the predetermined number of times is a representative statistic value of results of the second training operation of the individual number of times. The second training data pieces may include the first training data piece.

### BRIEF DESCRIPTION OF THE DRAWINGS

Various embodiments of the present disclosure will now be described more fully hereinafter with reference to the accompanying drawings; however, the embodiments may be embodied in different forms and should not be construed as limited to the embodiments set forth herein. Rather, these embodiments are provided so that this disclosure will be thorough and complete, and will fully convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a memory system in accordance with an embodiment of the present disclosure.

FIG. 2 is a detailed diagram of a memory controller shown in FIG. 1 in accordance with an embodiment of the present disclosure.

FIG. 3 is a detailed diagram of a memory device shown in FIG. 1 in accordance with an embodiment of the present disclosure.

FIG. 4 is a detailed diagram of a memory block included in a memory cell array shown in FIG. 3 in accordance with an embodiment of the present disclosure.

FIG. 5 is a detailed diagram of a device information area shown in FIG. 3 in accordance with an embodiment of the present disclosure.

FIG. 6 is a diagram for describing an example of training reference data shown in FIG. 5 in accordance with an embodiment of the present disclosure.

FIG. 7 is a flowchart for describing an operating method of the memory system in accordance with an embodiment of the present disclosure.

FIG. 8 is a flowchart for describing an operation performed when it is determined that no noise exists in FIG. 7 in accordance with an embodiment of the present disclosure.

FIG. 9 is a flowchart for describing an operation performed when it is determined that noise exists in FIG. 7 in accordance with an embodiment of the present disclosure.

FIG. 10 is a flowchart for describing a process of obtaining a final training result in FIG. 7 in accordance with an embodiment of the present disclosure.

FIG. 11 is a flowchart for describing an operating method of the memory system in accordance with another embodiment of the present disclosure.

FIG. 12 is a diagram illustrating a memory controller in accordance with another embodiment of the present disclosure.

FIG. 13 is a block diagram illustrating a memory card system to which the memory system in accordance with an embodiment of the present disclosure is applied.

FIG. 14 is a block diagram illustrating a Solid State Drive (SSD) system to which the memory system in accordance with an embodiment of the present disclosure is applied.

FIG. 15 is a block diagram illustrating a user system to which the memory system in accordance with an embodiment of the present disclosure is applied.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

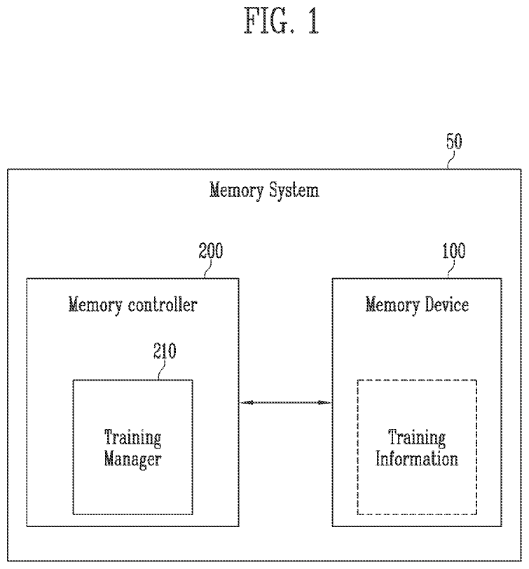

FIG. 1 is a diagram illustrating a memory system 50 in accordance with an embodiment of the present disclosure.

Referring to FIG. 1, the memory system 50 may include a memory device 100 and a memory controller 200. The memory system 50 may be a device for storing data under the control of a host, such as a mobile phone, a smart phone, an MP3 player, a laptop computer, a desktop computer, a game console, a TV, a tablet PC or an in-vehicle infotainment system. Alternatively, the memory system 50 may be a device for storing data under the control of the host for storing high-capacity data in one place, such as a server or a data center.

The memory system 50 may be manufactured as any of various types of memory systems according to a host interface that is a communication scheme with the host. For example, the memory system 50 may be configured with any of a variety of types of storage devices, such as a Solid State Drive (SSD), a multimedia card in the form of an MMC, an eMMC, an RS-MMC and a micro-MMC, a secure digital card in the form of an SD, a mini-SD and a micro-SD, a Universal Serial Bus (USB) memory module, a Universal Flash Storage (UFS) device, a personal computer memory card international association (PCMCIA) card type memory module, a peripheral component interconnection (PCI) card type memory module, a PCI express (PCI-E) card type memory module, a Compact Flash (CF) card, a Smart Media Card (SMC), and a memory stick.

The memory system 50 may be manufactured as any of various package types. For example, the memory system 50 may be manufactured as any of various package types such as a Package-On-Package (POP), a System-In-Package (SIP), a System-On-Chip (SOC), a Multi-Chip Package (MCP), a Chip-On-Board (COB), a Wafer-level Fabricated Package (WFP), and a Wafer-level Stack Package (WSP).

The memory device 100 may store data. The memory device 100 may operate under the control of the memory controller 200. The memory device 100 may include a memory cell array (not shown) including a plurality of memory cells for storing data.

Each of the memory cells may be configured as any of a Single Level Cell (SLC) storing one data bit, a Multi-Level Cell (MLC) storing two data bits, a Triple Level Cell (TLC) storing three data bits, and a Quadruple Level Cell (QLC) storing four data bits.

The memory cell array (not shown) may include a plurality of memory blocks. Each memory block may include a plurality of memory cells. Each memory block may include a plurality of pages. In an embodiment, the page may be a unit for storing data in the memory device 100 or reading data stored in the memory device 100. The memory block may be a unit for erasing data.

In an embodiment, the memory device 100 may be a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), a NAND flash memory, a vertical NAND flash memory, a NOR flash memory, a Resistive Random Access Memory (RRAM), a Phase-Change Random Access Memory (PRAM), a Magnetoresistive Random Access Memory (MRAM), a Ferroelectric Random Access Memory (FRAM), a Spin Transfer Torque Random Access Memory (STT-RAM), or the like. In this specification, for convenience of description, a case where the memory device 100 is a NAND flash memory is described.

The memory device 100 may receive a command and an address from the memory controller 200, and access an area selected by the address in the memory cell array. The memory device 100 may perform an operation indicated by the command on the area selected by the address.

For example, the memory device 100 may perform a write operation (program operation), a read operation, and an erase operation. In the program operation, the memory device 100 may program data in the area selected by the address. In the read operation, the memory device 100 may read data from the area selected by the address. In the erase operation, the memory device 100 may erase data stored in the area selected by the address. In an embodiment, training information may be stored in the memory device 100.

The memory controller 200 may control overall operations of the memory system 50.

When power is applied to the memory system 50, the memory controller 200 may execute firmware (FW). When the memory device 100 is a flash memory device, the memory controller 200 may execute FW such as a flash translation layer (FTL) for controlling communication between the host and the memory device 100.

In an embodiment, the memory controller 200 may receive a Logical Address (LA) from the host, and translate the LA into a Physical Address (PA) representing addresses of memory cells in the memory device 100, in which data is to be stored or from which data is to be read.

The memory controller 200 may control the memory device 100 to perform a program operation, a read operation, an erase operation, or the like in response to a request from the host. In the program operation, the memory controller 200 may provide a program command, a PA, and data to the memory device 100. In the read operation, the memory controller 200 may provide a read command and a PA to the memory device 100. In the erase operation, the memory controller 200 may provide an erase command and a PA to the memory device 100.

In an embodiment, the memory controller 200 may autonomously generate a command, an address, and data regardless of any request from the host, and transmit the command, the address, and the data to the memory device 100. For example, the memory controller 200 may provide the memory device 100 with a command, an address, and data, which are used to perform read and program operations accompanied in performing wear leveling, read reclaim, garbage collection, or the like.

In an embodiment, the memory controller 200 may control at least two memory devices 100. The memory controller 200 may control the memory devices 100 according to an interleaving scheme to improve operational performance. The interleaving scheme may be a scheme for controlling operations on at least two memory devices 100 to overlap with each other.

In an embodiment, the memory controller 200 may include a training manager 210 which controls a training operation. The training manager 210 may perform the training operation such that data is normally moved between the memory controller 200 and the memory device 100, regardless of any variable according to a process, a voltage, and a temperature. The training operation may be an operation of optimizing a phase, an amplitude, and the like of a signal exchanged between the memory device 100 and the memory controller 200 such that the memory device 100 and the memory controller 200 exchanged accurate data with each other. For example, the training operation may be a duty cycle correction (DCC) training operation, a read training operation, or a write training operation. The training manager 210 may generate training data, and perform the training operation by using the generated training data.

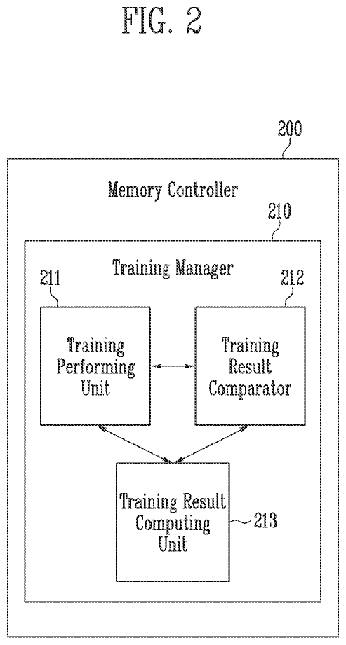

FIG. 2 is a detailed diagram of the memory controller 200 shown in FIG. 1 in accordance with an embodiment of the present disclosure.

Referring to FIG. 2, the memory controller 200 may include a training manager 210.

In an embodiment, the training manager 210 may include a training performing unit 211, a training result comparator 212, and a training result computing unit 213.

The training performing unit 211 may perform a training operation, based on training information stored in the memory device 100. In an embodiment, the training performing unit 211 may perform a first training operation, based on first training information stored in the memory device 100. The first training information may include a training pattern optimized for the memory system 50 in an environment with no noise. Herein, noise may be any kind of conditions that cause errors in training results. In another embodiment, the training performing unit 211 may perform a second training operation, based on the first training information or second training information, which is stored in the memory device 100. The first training information may include a training pattern optimized for the memory system 50 in an environment with no noise, and the second training information may include a training pattern optimized for the memory system 50 in an environment with noise. The training pattern included in the first training information and the training pattern included in the second training information may be different from each other. In an embodiment, the second training information may be information on a plurality of training patterns. For example, the second training information may include a plurality of training patterns which vary according to a degree of noise. In an embodiment, the training performing unit 211 may perform the second training operation while changing a training pattern. The training performing unit 211 may change the training pattern by autonomously deciding a training result, or change the training pattern, based on information on a noise environment, received from the training result comparator 212. The training pattern may be changed to be differently applied according to a noise degree. In an embodiment, when the training result comparator 212 decides that the memory system 50 is exposed to the noise environment, the training performing unit 211 may perform the second training operation. The training performing unit 211 may determine training information on which the second training operation is to be performed, based on a decision about whether the noise environment of the training result comparator 212 is continued. For example, when the training result comparator 212 decides that the noise environment is continued, the training performing unit 211 may perform the second training operation, based on the first training information. Alternatively, when the training result comparator 21 decides that the memory system 50 is merely temporarily exposed to the noise environment, the training performing unit 211 may perform the second training operation, based on the second training information. In an embodiment, the training performing unit 211 may perform the second training operation plural times. A number of training operations which the training performing unit 211 is to perform may be predetermined.

The training result comparator 212 may compare a result of the training performed by the training performing unit 211 with training reference data stored in the memory device 100. In an embodiment, the training result comparator 212 may decide whether the memory system 50 is exposed to the noise environment, based on comparison for a training result. For example, when the training result is out of a predetermined range, based on the training reference data, the training result comparator 212 may decide that the memory system 50 is exposed to the noise environment. Also, the training result comparator 212 may decide whether the memory system 50 is continuously exposed to the noise environment or whether the memory system 50 is temporarily exposed to the noise environment, based on the comparison for the training result. The training result comparator 212 may again compare the training result with the training reference data after a certain time from a time at which the training result comparator 212 decides that the memory system 50 is exposed to the noise environment. When the training result is out of the predetermined range, based on the training reference data, the training result comparator 212 may decide that the memory system 50 is continuously exposed to the noise environment. On the other hand, when the training result comparator 212 again compares the training result with the training reference data after a certain time from the time at which the training result comparator 212 decides that the memory system 50 is exposed to the noise environment, the training result comparator 212 may decide that the memory system 50 is merely temporarily exposed to the noise environment when the training result is not out of the predetermined range, based on the training reference data. The training result comparator 212 may provide the training performing unit 211 and the training result computing unit 213 with information on whether the memory system 50 is exposed to the noise environment and whether the noise environment is continued.

The training result computing unit 213 may compute a final training result, based on results of training operations performed by the training performing unit 211. In an embodiment, when the training result computing unit 213 receives information representing that the memory system 50 is not exposed to the noise environment from the training result comparator 212, the training result computing unit 213 may compute, as the final training result, a result for the first training operation performed by the training performing unit 211. In an embodiment, when the training result computing unit 212 receives information representing that the memory system 50 is exposed to the noise environment from the training result comparator 212 or when the training result computing unit 212 receives information on the second training operation performed by the training performing unit 211 as the memory system 50 is exposed to the noise environment, the training result computing unit 213 may compute the final training result by considering a result for the second training operation performed by the training performing unit 211. The second training operation may be performed plural times, and the training result computing unit 213 may compute the final training result by accumulating results of second training operations performed the plural times. For example, the training result computing unit 212 may compute the final training result by accumulating and calculating an average value of the results of the second training operations. Alternatively, the training result computing unit 212 may compute the final training result by applying various filter algorithms to the results of the second training operations. That is, the training result computing unit 213 considers all results for training operations which can be performed plural times, thereby acquiring a training result of which consistency is further ensured.

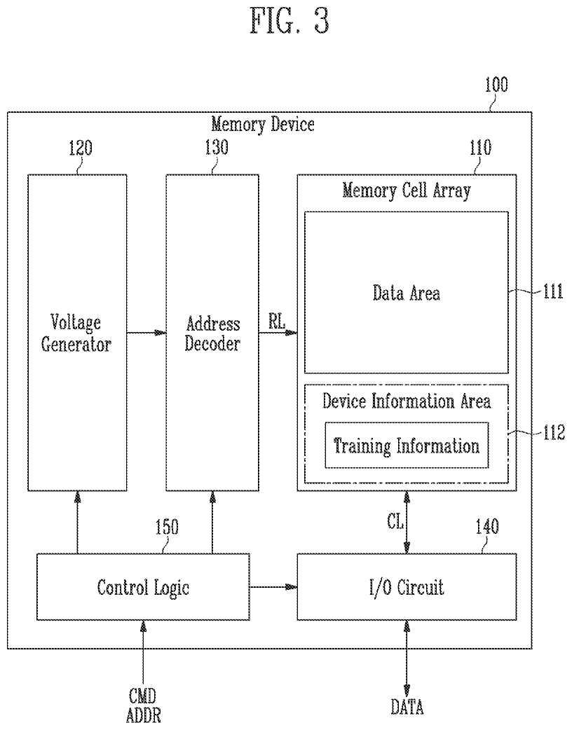

FIG. 3 is a detailed diagram of the memory device 100 shown in FIG. 1 in accordance with an embodiment of the present disclosure.

Referring to FIG. 3, the memory device 100 may include a memory cell array 110, a voltage generator 120, an address decoder 130, an input/output (I/O) circuit 140, and a control logic 150.

The memory cell array 110 may include a plurality of memory blocks. The plurality of memory blocks may be connected to the address decoder 130 through row lines RL. The plurality of memory blocks may be connected to the input/output circuit 140 through column lines CL. In an embodiment, the row lines RL may include word lines, source select lines, and drain select lines. In an embodiment, the column lines CL may include bit lines.

Each of the plurality of memory blocks includes a plurality of memory cells. In an embodiment, the plurality of memory cells may be nonvolatile memory cells. Memory cells connected to the same word line among the plurality of memory cells may be defined as one physical page. That is, the memory cell array 110 may include a plurality of physical pages. Each of the memory cells of the memory device 100 may be configured as a Single Level Cell (SLC) storing one data bit, a Multi-Level Cell (MLC) storing two data bits, a Triple Level Cell (TLC) storing three data bits, or a Quad Level Cell (QLC) storing four data bits.

In an embodiment, a data area 111 may exist in one area of the memory cell array 110, and a device information area 112 may exist in another area of the memory cell array 110. The data area 111 is an area in which data received from the host is stored, and may be an area which the host can access. The device information area 112 is an area in which data necessary for an operation of the memory system 50, internal configuration setting data of the memory device 100, and the like are stored, and may be an area which the host cannot access.

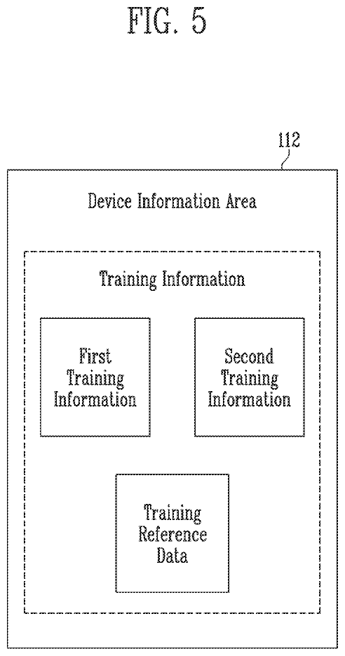

In an embodiment, training information may be stored in the device information area 112. The training information will be described in more detail hereinbelow with reference to FIG. 5.

In an embodiment, the voltage generator 120, the address decoder 130, and the input/output circuit 140 may be commonly designated as a peripheral circuit. The peripheral circuit may drive the memory cell array 110 under the control of the control logic 150. The peripheral circuit may drive the memory cell array 110 to perform a program operation, a read operation, and an erase operation.

The voltage generator 120 may generate a plurality of operating voltages by using an external power voltage supplied to the memory device 100. The voltage generator 120 may operate under the control of the control logic 150.

In an embodiment, the voltage generator 120 may generate an internal power voltage by regulating the external power voltage. The internal power voltage generated by the voltage generator 120 may be used as an operating voltage of the memory device 100.

In an embodiment, the voltage generator 120 may generate a plurality of operating voltages by using the external power voltage or the internal power voltage. The voltage generator 120 may generate various voltages required in the memory device 100. For example, the voltage generator 120 may generate a plurality of erase voltages, a plurality of program voltages, a plurality of pass voltages, a plurality of select read voltages, and a plurality of unselect read voltages.

In order to generate a plurality of operating voltages having various voltage levels, the voltage generator 120 may include a plurality of pumping capacitors which receive the internal power voltage. The voltage generator 120 may generate the plurality of operating voltages by selectively activating the plurality of pumping capacitors under the control of the control logic 150.

The plurality of operating voltages generated by the voltage generator 120 may be supplied to the memory cell array 110 by the address decoder 130.

The address decoder 130 may be connected to the memory cell array 110 through the row lines RL. The address decoder 130 may operate under the control of the control logic 150. The address decoder 130 may receive an address ADDR from the control logic 150. The address decoder 130 may decode a block address in the received address ADDR. The address decoder 130 may select at least one memory block among the memory blocks according to the decoded block address. The address decoder 130 may decode a row address in the received address ADDR. The address decoder 130 may select at least one word line among word lines of the selected memory block according to the decoded row address. In an embodiment, the address decoder 130 may decode a column address in the received address ADDR. The address decoder 130 may connect the input/output circuit 140 and the memory cell array 110 to each other according to the decoded column address.

The address decoder 130 may include components such as a row decoder, a column decoder, and an address decoder.

The input/output circuit 140 may include a plurality of page buffers. The plurality of page buffers may be connected to the memory cell array 110 through the bit lines. In a program operation, data may be stored in selected memory cells according to data stored in the plurality of page buffers.

In a read operation, the data stored in the selected memory cells may be sensed through the bit lines, and the sensed data may be stored in the page buffers.

The control logic 150 may control the address decoder 130, the voltage generator 120, and the input/output circuit 140. The control logic 150 may operate in response to a command CMD transferred from an external device. The control logic 150 may control the peripheral circuit by generating control signals in response to the command CMD and the address ADDR.

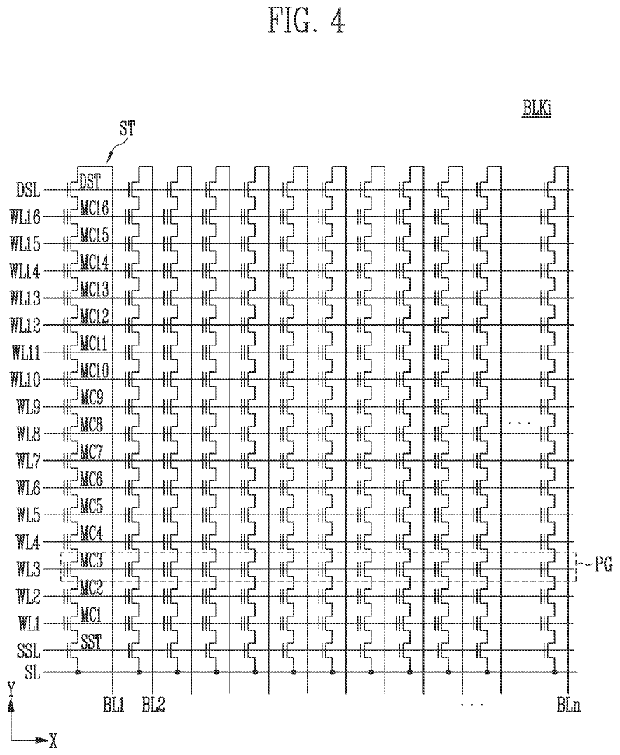

FIG. 4 is a detailed diagram of a memory block BLKi included in the memory cell array shown in FIG. 3 in accordance with an embodiment of the present disclosure.

The memory block BLKi represents a memory block BLKi among the plurality of memory blocks included in the memory cell array shown in FIG. 3.

Referring to FIG. 4, in the memory block BLKi, a plurality of word lines arranged in parallel to each other may be connected between a first select line and a second select line. The first select line may be a source select line SSL, and the second select line may be a drain select line DSL. More specifically, the memory block BLKi may include a plurality of strings ST connected between bit lines BLi to BLn and a source line SL. The bit lines BLi to BLn may be respectively connected to the strings ST, and the source line SL may be commonly connected to the strings ST. The strings ST may be configured identically to one another, and therefore, a string ST connected to a first bit line BLi will be described in detail as an example.

The string ST may include a source select transistor SST, a plurality of memory cells MC1 to MC16, and a drain select transistor DST, which are connected in series to each other between the source line SL and the first bit line BLi. At least one drain select transistor DST may be included in one string ST, and source select transistors of which a number is greater than that of the source select transistor SST shown in the drawing and memory cells of which a number is greater than that of the memory cells MC1 to MC16 shown in the drawing may be included in the one string ST.

A source of the source select transistor SST may be connected to the source line SL, and a drain of the drain select transistor DST may be connected to the first bit line BL1. The memory cells MC1 to MC16 may be connected in series between the source select transistor SST and the drain select transistor DST. Gates of source select transistors SST included in different strings ST may be connected to the source select line SSL, and gates of drain select transistors DST included in different strings ST may be connected to the drain select line DSL. Gates of the memory cells MC1 to MC16 may be connected to a plurality of word lines WL1 to WL16. A group of memory cells connected to the same word line among memory cells included in different strings ST may be referred to as a physical page PG. Therefore, physical pages PG corresponding to the number of the word lines WL1 to WL16 may be included in the memory block BLKi.

One memory cell may store one-bit data. The one memory cell is generally referred to as a single level cell (SLC). One physical page PG may store one logical page (LPG) data. One LPG data may include data bits corresponding to the number of cells included in the one physical page PG.

One memory cell may store two or more-bit data. One physical page PG may store two or more LPG data.

FIG. 5 is a detailed diagram of the device information area 112 shown in FIG. 3 in accordance with an embodiment of the present disclosure.

Referring to FIGS. 1, 3, and 5, training information may be stored in the device information area 112. The training information may include first training information, second training Information, and training reference data.

The first training information may include a training pattern optimized in an environment which is not exposed to noise. The first training information may be used for a first training operation preferentially performed to determine whether the memory system 50 is in an environment exposed to noise. Also, the first training information may be used for an operation for deciding whether the memory system 50 is continuously exposed to noise. Also, when it is determined that the memory system 50 is temporarily exposed to noise, the first training information may be used for a second training operation performed subsequently to the first training operation.

The second training information may include a training pattern optimized in an environment exposed to noise. When it is determined that the memory system 50 is continuously exposed to noise, the second training information may be used for the second training operation performed subsequently to the first training operation. The second training information may include a plurality of patterns which vary according to a degree of noise. For example, the second training information may include a plurality of patterns which vary according to a degree to which a training result is out of a predetermined range, based on the training reference data. The predetermined range may represent that a normal training result has been obtained. When the training result is out of the predetermined range, this may represent that an abnormal training result has been obtained.

The reference data information may be data used as a reference for deciding that the memory system 50 is continuously exposed to noise. The reference data information may include information on the predetermined range representing that a normal training result has been obtained. In an embodiment, the reference data information may be acquired based on the first training information. For example, the reference data information may be data acquired by repeatedly performing a test operation in an environment with no noise, based on the first training information. The test operation may be an operation of repeatedly performing a training operation based on the first training information while changing an operational environment of the memory system 50, such as temperature, voltage or humidity.

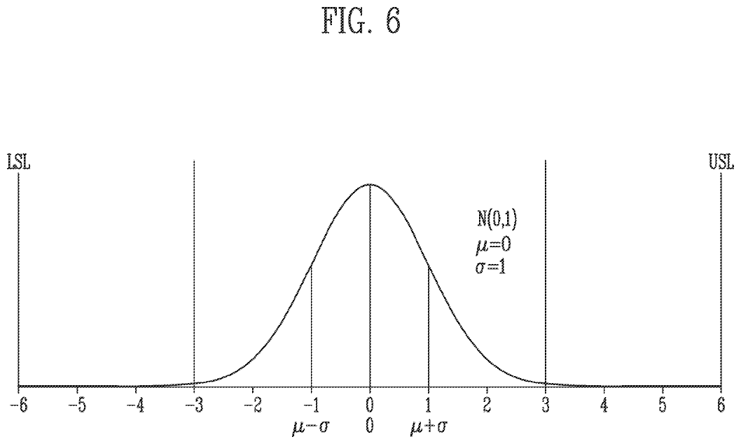

FIG. 6 is a diagram for describing an example of the training reference data shown in FIG. 5 in accordance with an embodiment of the present disclosure.

Referring to FIGS. 5 and 6, the training reference data may be standard distribution data acquired by accumulating data obtained by repeating the test operation in an environment with no noise, based on the first training information. In an embodiment, a training operation may be repeatedly performed while changing an operational condition within an operational range of the memory system 50, based on the first training information, and data associated with an average, a standard deviation, a distribution, and the like of training result values according to the test operation by accumulating data obtained by repeatedly performing the training operation. In an embodiment, standard distribution data of the accumulated training result values may be acquired as shown in FIG. 6, and it may be predetermined that values in a specific range represent a normal training result, based on the acquired standard distribution data. For example, it may be predetermined that a value within ±3σ in the standard distribution data is a normal training result. A training result acquired in a subsequent training operation may be compared with the training reference data shown in FIG. 6, thereby deciding whether the memory system 50 has been exposed to a noise environment. When a training result according to the training operation belongs within a predetermined range, the acquired training result may be identified as a normal training result by the training manager 210. When the training result is out of the predetermined range, the acquired training result is an abnormal training result, and accordingly, it may be determined by the training manager 210 that the memory system 50 has been exposed to the noise environment.

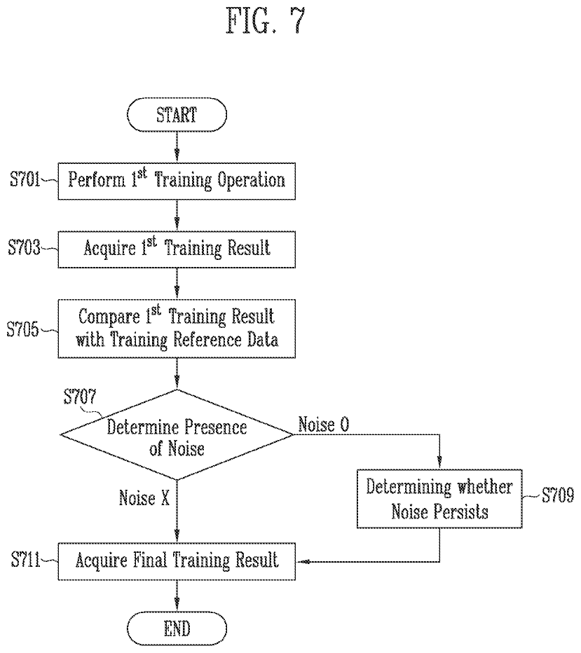

FIG. 7 is a flowchart for describing an operating method of the memory system in accordance with an embodiment of the present disclosure.

Referring to FIGS. 1 and 7, in operation S701, the memory system 50 may perform a first training operation on the memory device 100. Accordingly, in operation S703, the memory system 50 may acquire a first training result. The first training operation may be performed to determine whether the memory system 50 is exposed to a noise environment. The first training operation may be performed based on first training Information stored in the memory device 100.

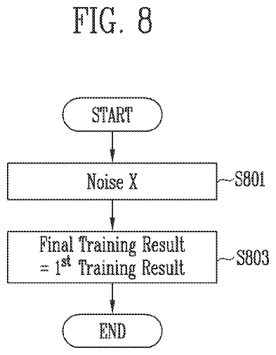

In operation S705, the memory system 50 may compare the acquired first training result with training reference data stored in the memory device 100. Accordingly, in operation S707, the memory system 50 may decide whether noise exists. When it is determined that no noise exists in the operation S707, the memory system 50 may acquire a final training result immediately in operation S711. When it is determined that noise exists in the operation S707, in operation S709, the memory system 50 may decide whether the noise is continued. In the operation S711, the memory system 50 may acquire the final training result, based on the decision result of the operation S709. A process of acquiring the final training result will be described in more detail hereinbelow with reference to FIGS. 8 to 10.

FIG. 8 is a flowchart for describing an operation when it is determined that no noise exists in FIG. 7 in accordance with an embodiment of the present disclosure.

FIG. 8 illustrates the operations S707 and S711 shown in FIG. 7.

When it is determined that no noise exists in operation S801, in operation S803, the memory system 50 may determine, as the final training result, the first training result acquired in the operation S703 shown in FIG. 7. That is, as a result obtained by comparing the first training result with the training reference data in the operation S705 shown in FIG. 5, it has been checked that the first training result belongs within the predetermined normal range, and therefore, the first training result may be used immediately as the final training result.

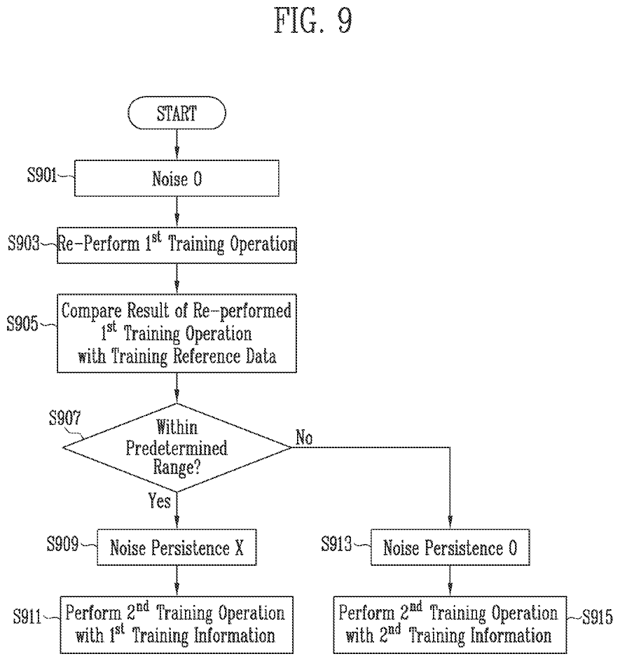

FIG. 9 is a flowchart for describing an operation when it is determined that noise exists in FIG. 7 in accordance with an embodiment of the present disclosure.

FIG. 9 illustrates the operation S709 shown in FIG. 7.

When it is determined that noise exists in operation S901, in operation S903, the memory system 50 may re-perform the first training operation, based on the first training information stored in the memory device 100. Accordingly, in operation S905, a training result acquired by re-performing the first training operation may be again compared with the reference data.

When the training result acquired by re-performing the first training operation belongs within a predetermined range of the training reference data, i.e., a range representing that the training result is normal in operation S907, in operation S909, the memory system 50 may determine that the noise is not continued. Accordingly, in operation S911, the memory system 50 may perform a second training operation, based on the first training information stored in the memory device 100.

When the training result acquired by re-performing the first training operation is out of the predetermined range of the training reference data in the operation S907, i.e., when it is represented that the training result is abnormal, in operation S913, the memory system 50 may determine that the noise is continued. Accordingly, in operation S15, the memory system 50 may perform the second training operation, based on second training information stored in the memory device 100.

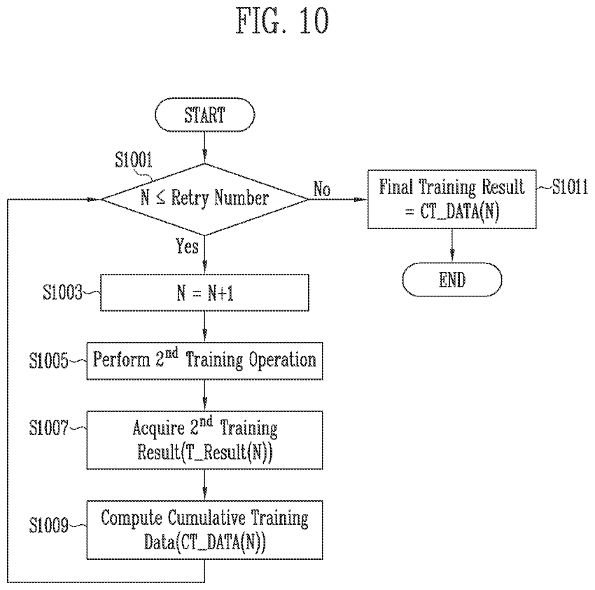

FIG. 10 is a flowchart for describing the process of obtaining the final training result in FIG. 7 in accordance with an embodiment of the present disclosure.

FIG. 10 illustrates the operation S711 performed subsequently to the operation S709 shown in FIG. 7. That is, FIG. 10 illustrates the process of acquiring the final training result when it is determined that noise exists as the comparison result in the operation S705 with respect to the first training result shown in FIG. 7.

The second training operation performed in the operation S911 or S915 shown in FIG. 9 may be repeated by a predetermined number of times. Accordingly, in operation S1001, the memory system 50 may determine whether a repetition number N of a current second training operation exceeds a predetermined second training operation repetition number Retry Number.

When the repetition number N of the current second training operation is equal to or less than the predetermined second training operation repetition number Retry Number, in operation S1003, the memory system 50 increases the repetition number N of the second training operation by 1. In operation S1005, the memory system 50 may perform the second training operation. Accordingly, in operation S1007, the memory system 50 may obtain a second training result T_Result(N). When it is determined that the noise is not continued as shown in the operation S911 shown in FIG. 9, the second training operation may be performed based on the first training information stored in the memory device 100. When it is determined that the noise is continued as shown in the operation S915 shown in FIG. 9, the second training operation may be performed based on the second training information stored in the memory device 100.

In operation S1009, the memory system 50 may compute accumulated training data CT_DATA(N). The accumulated training data CT_DATA(N) may be a value obtained by accumulating repeated second training results T_Result(1) to T_Result(N). In an embodiment, the accumulated training data CT_DATA(N) may be acquired based on a current second training result T_Result(N) and previous accumulated training data CT_DATA(N−1). For example, the accumulated training data CT_DATA(N) may be an average value of the current second training result T_Result(N) and the previous accumulated training data CT_DATA(N−1). Alternatively, the current second training result T_Result(N) and the previous accumulated training data CT_DATA(N−1) may be applied to various filter algorithms, thereby acquiring the accumulated training data CT_DATA(N).

After that, returning to the operation S1001, the memory system 50 may determine whether the repetition number N of the current second training operation exceeds the predetermined second training operation repetition number Retry Number. The operations S1001 to S1009 may be repeated until the repetition number N of the current second training operation exceeds the predetermined second training operation repetition number Retry Number. In an embodiment, when the second training operation is repeated, a training pattern used for the second training operation may be changed under the control of the memory controller 200.

When the repetition number N of the current second training operation exceeds the predetermined second training operation repetition number Retry Number, in operation S1011, the memory system 50 may determine last accumulated training data CT_DATA(N) as the final training result. The last accumulated training data CT_DATA(N) may be a value obtained by reflecting all result values of second training operations which are repeatedly performed. Accordingly, more improved consistency with respect to the training operation can be expected.

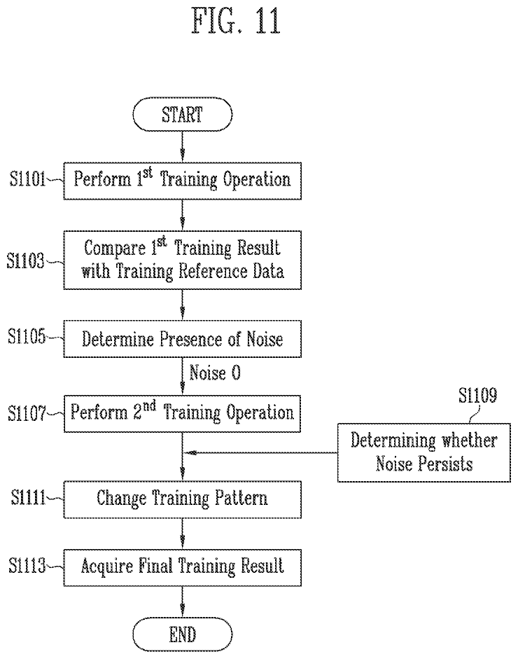

FIG. 11 is a flowchart for describing an operating method of the memory system 50 in accordance with another embodiment of the present disclosure.

Referring to FIGS. 1 and 11, in operation S1101, the memory system 50 may perform a first training operation on the memory device 100. Accordingly, in operation S1103, the memory system 50 may compare a first training result acquired according to the first training operation with training reference data stored in the memory device 100. The first training operation may be performed to determine whether the memory system 50 is exposed to a noise environment. The first training operation may be performed based on first training information stored in the memory device 100.

In operation S1105, the memory system 50 may determine whether noise exists. When it is determined that noise exists, in operation S1107, the memory system 50 may perform a second training operation. The second training operation may be repeatedly performed plural times as described in FIG. 10. In an embodiment, an initial second training operation may be performed based on second training information stored in the memory device 100.

While the second training operation is performed, in operation S1109, the memory system 50 may determine whether the noise is continued. In an embodiment, the determining of whether the noise is continued may be performed by repeating the operations S1101, S1103, and S1105, based on the first training information and the training reference data, which are stored in the memory device 100.

In operation S1111, the memory system 50 may perform a second training operation by changing a training pattern, based on whether the noise is continued, which is determined in the operation S1109. In an embodiment, when it is determined that the noise is not continued according to the operation S1109, a second training operation which is repeated subsequently may be performed based on a training pattern included in the first training information instead of the second training information. In another embodiment, when the noise becomes large or small as compared with in the first training operation, the training pattern may be changed to one of a plurality of training patterns included in the second training information corresponding to the degree to which the noise becomes large or small, and the second training operation may be continuously performed based on the changed training pattern.

When the second training operation is repeated by a predetermined number of times, in operation S1113, the memory system 50 may acquire a final training result. The operation S1113 may be performed in the same method as FIG. 10.

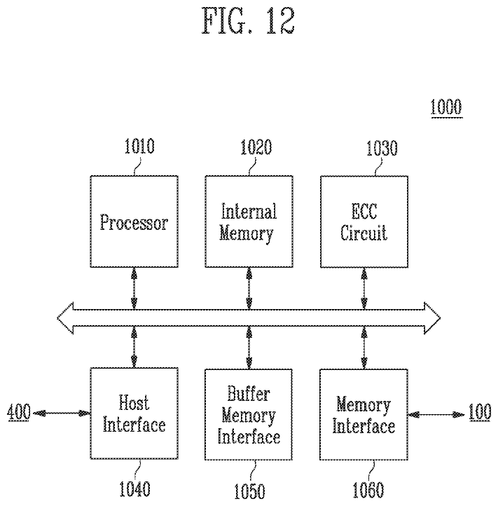

FIG. 12 is a diagram illustrating a memory controller 1000 in accordance with another embodiment of the present disclosure.

Referring to FIG. 12, the memory controller 1000 may include a processor 1010, an internal memory 1020, an error correction code (ECC) circuit 1030, a host interface 1040, a buffer memory interface 1050, and a memory interface 1060.

The processor 1010 may perform various calculations for controlling the memory device 100 or generate various commands. When the processor 1010 receives a request from a host 400, the processor 1010 may generate a command according to the received request, and transmit the generated command to a queue controller (not shown).

The internal memory 1020 may store various information necessary for an operation of the memory controller 1000. For example, the internal memory 1020 may include logical and physical address map tables. The internal memory 1020 may be configured with at least one of a random access memory (RAM), a dynamic RAM (DRAM), a static RAM (SRAM), a cache, and a tightly coupled memory (TCM).

The ECC circuit 1030 is configured to detect and correct an error of data received from the memory device 100 by using an error correction code (ECC). The processor 1010 may adjust a read voltage according to an error detection result of the ECC circuit 1030, and control the memory device 100 to perform re-reading. In an embodiment, an error correction block may be provided as a component of the memory controller 1000.

The host interface 1040 may exchange a command, an address, and data between the memory controller 1000 and the host 400. For example, the host interface 1040 may receive a request, an address, data, and the like from the host 400, and output data read from the memory device to the host 400. The host interface 1040 may communicate with the host 400 by using various protocols.

The buffer memory interface 1050 may transfer data between the processor 1010 and a buffer memory. The buffer memory may be used as a working memory or a cache memory of the memory controller 1000, and store data used in the memory system 50. The buffer memory interface 1050 may use the buffer memory as a read buffer, a write buffer, a map buffer, or the like under the control of the processor 1010. In some embodiments, the buffer memory may include a Double Data Rate Synchronous Dynamic Random Access Memory (DDR SDRAM), a DDR4 SRAM, a Low Power Double Data Rate4 (LPDDR4) SDRAM, a Graphics Double Data Rate (GDDR) SDRAM, a Low Power DDR (LPDDR), or a Rambus Dynamic Random Access Memory (RDRAM).

The memory interface 1060 may exchange a command, an address, data, and the like between the memory controller 1000 and the memory device 100. For example, the memory interface 1060 may transfer a command, an address, data, and the like to the memory device 100 through a channel, and receive data and the like from the memory device 100. The memory interface 1060 may perform a training operation on the memory device 100, based on training information stored in the memory device 100, according to an instruction of the processor 1010.

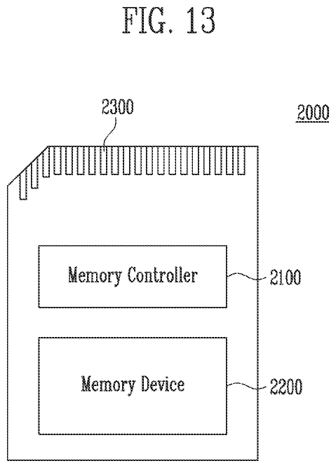

FIG. 13 is a block diagram illustrating a memory card system 2000 to which the memory system in accordance with an embodiment of the present disclosure is applied.

Referring to FIG. 13, the memory card system 2000 includes a memory controller 2100, a memory device 2200, and a connector 2300.

The memory controller 2100 is connected to the memory device 2200. The memory controller 2100 may access the memory device 2200. For example, the memory controller 2100 may control read, program, erase, and background operations of the memory device 2200. The memory controller 2100 provides an interface between the memory device 2200 and a host. The memory controller 2100 drives firmware for controlling the memory device 2200. The memory controller 2100 may be implemented identically to the memory controller 200 described with reference to FIG. 1. The memory device 2200 may be implemented identically to the memory device 100 described with reference to FIG. 1.

The memory controller 2100 may include components such as a Random Access Memory (RAM), a processing unit, a host interface, a memory interface, and an ECC circuit.

The memory controller 2100 may communicate with an external device through the connector 2300. The memory controller 2100 may communicate with the external device (e.g., the host) according to a specific communication protocol. The memory controller 2100 is configured to communicate with the external device through at least one of various communication protocols. The connector 2300 may be defined by at least one of the above-described various communication protocols.

The memory device 2200 may be implemented with various nonvolatile memory devices such as an Electrically Erasable and Programmable ROM (EEPROM), a NAND flash memory, a NOR flash memory, a Phase-change RAM (PRAM), a Resistive RAM (ReRAM), a Ferroelectric RAM (FRAM), and a Spin Torque Transfer magnetic RAM (STT-MRAM). In an embodiment, training information for a training operation may be stored in the memory device 2200. The training information may be provided to the memory controller 2100 for the purpose of the training operation.

The memory controller 2100 and the memory device 2200 may be integrated into a single semiconductor device, to constitute a memory card. For example, the memory controller 2100 and the memory device 2200 may constitute a memory card such as a PC card (Personal Computer Memory Card International Association (PCMCIA)), a Compact Flash (CF) card, a Smart Media Card (SM and SMC), a memory stick, a Multi-Media Card (MMC, RS-MMC, MMCmicro and eMMC), an SD card (SD, miniSD, microSD and SDHC), and a Universal Flash Storage (UFS).

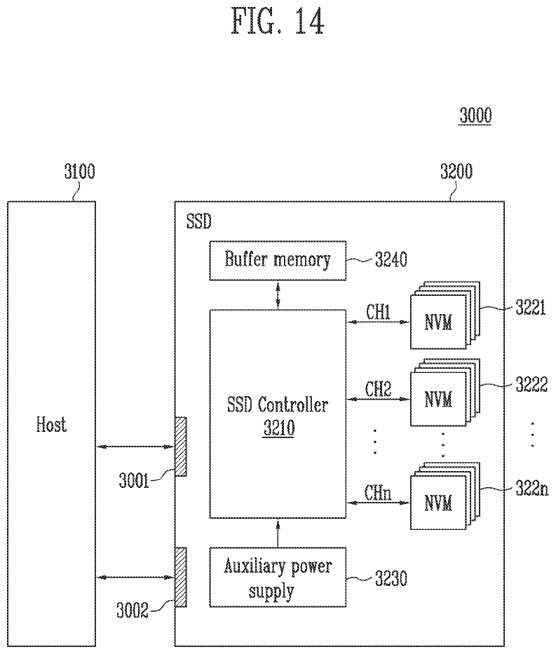

FIG. 14 is a block diagram illustrating a Solid State Drive (SSD) system 3000 to which the memory system in accordance with an embodiment of the present disclosure is applied.

Referring to FIG. 14, the SSD system 3000 includes a host 3100 and an SSD 3200. The SSD 3200 exchanges a signal with the host 3100 through a signal connector 3001, and receives power through a power connector 3002. The SSD 3200 includes an SSD controller 3210, a plurality of flash memories 3221 to 322n, an auxiliary power supply 3230, and a buffer memory 3240.

In an embodiment, the SSD controller 3210 may serve as the memory controller 200 described with reference to FIG. 1.

The SSD controller 3210 may control the plurality of flash memories 3221 to 322n in response to a signal received from the host 3100. The signal may be a signal based on an interface between the host 3100 and the SSD 3200. The signal may be transmitted/received in forms of various commands. The signal may be a signal requesting the SSD controller 3210 to access a security storage area located in some of the plurality of flash memories 3221 to 322n, or a signal as a response to such a request. In an embodiment, the SSD controller 3210 may perform a training operation on the plurality of flash memories 3221 to 322n, based on training information stored in some of the plurality of flash memories 3221 to 322n.

The auxiliary power supply 3230 is connected to the host 3100 through the power connector 3002. The auxiliary power supply 3230 may receive the power PWR input from the host 3100, and charge the power PWR. When the supply of power from the host 3100 is not smooth, the auxiliary power supply 3230 may provide power to the SSD 3200. The auxiliary power supply 3230 may be located in the SSD 3200, or be located at the outside of the SSD 3200. For example, the auxiliary power supply 3230 may be located on a main board, and provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or temporarily store metadata (e.g., a mapping table) of the flash memories 3221 to 322n. The buffer memory 3240 may include volatile memories such as a DRAM, an SDRAM, a DDR SDRAM, an LPDDR SDRAM, and a GRAM or nonvolatile memories such as a FRAM, a ReRAM, an STT-MRAM, and a PRAM.

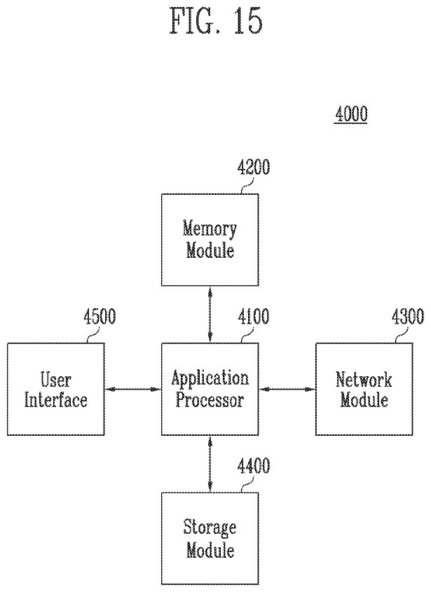

FIG. 15 is a block diagram illustrating a user system 4000 to which the memory system is applied in accordance with an embodiment of the present disclosure.

Referring to FIG. 15, the user system 4000 includes an application processor 4100, a memory module 4200, a network module 4300, a storage module 4400, and a user interface 4500.

The application processor 4100 may drive components included in the user system 4000, an operating system (OS), a user program, or the like. The application processor 4100 may include controllers for controlling components included in the user system 4000, interfaces, a graphic engine, and the like. The application processor 4100 may be provided as a System-on-Chip (SoC).

The memory module 4200 may operate as a main memory, working memory, buffer memory or cache memory of the user system 4000. The memory module 4200 may include a volatile random access memory or a nonvolatile random access memory. The application processor 4100 and the memory module 4200 may be packaged based on a Package on Package (PoP) to be provided as one semiconductor package.

The network module 4300 may communicate with external devices. The network module 4300 may support wireless communications such as Code Division Multiple Access (CDMA), Global System for Mobile communication (GSM), Wideband CDMA (WCDMA), CDMA-2000, Time Division Multiple Access (TDMA), Long Term Evolution (LTE), Wimax, WLAN, UWB, Bluetooth, and Wi-Fi. The network module 4300 may be included in the application processor 4100.

The storage module 4400 may store data. For example, the storage module 4400 may store data received from the application processor 4100. Alternatively, the storage module 4400 may transmit data stored therein to the application processor 4100. The storage module 4400 may be implemented with a nonvolatile semiconductor memory device such as a Phase-change RAM (PRAM), a Magnetic RAM (MRAM), a Resistive RAM (RRAM), a NAND flash, a NOR flash, or a NAND flash having a three-dimensional structure. The storage module 4400 may be provided as a removable drive such as a memory card of the user system 4000 or an external drive.

The storage module 4400 may include a plurality of nonvolatile memory devices, and the plurality of nonvolatile memory devices may operate identically to the memory device 100 described with reference to FIG. 1. Therefore, training data including various training pattern information corresponding to several conditions may be stored in the storage module 4400.

The user interface 4500 may include interfaces for inputting data or commands to the application processor 4100 or outputting data to an external device. The user interface 4500 may include user input interfaces such as a keyboard, a keypad, a button, a touch panel, a touch screen, a touch pad, a touch ball, a camera, a microphone, a gyroscope sensor, a vibration sensor and a piezoelectric element. The user interface 4500 may include user output interfaces such as a Liquid Crystal Display (LCD), an Organic Light Emitting Diode (OLED) display device, an Active Matrix OLED (AMOLED) display device, an LED, a speaker, and a monitor.

In accordance with the present disclosure, there can be provided a memory system and an operating method thereof, which provide improved reliability and stability.

While the present disclosure has been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein and the following claims. Furthermore, the embodiments may be combined to form additional embodiments.

What is claimed is:

1. A memory system comprising:
a memory device configured to store first training information and second training information representing different training patterns; and
a memory controller configured to:
perform a first training operation on the memory device based on the first training information, and
perform, when a result of the first training operation is out of a predetermined range, a second training operation on the memory device plural times based on the second training information.

2. The memory system of claim 1, wherein the memory controller is further configured to compute a final training value according to the second training operations performed the plural times.

3. The memory system of claim 1, wherein the predetermined range is acquired based on the first training information.

4. The memory system of claim 1, wherein the second training information represents a plurality of training patterns which vary according to a degree to which the result of the first training operation is out of the predetermined range.

5. The memory system of claim 4, wherein the memory controller performs the second training operation respectively based on two or more training patterns among the plurality of training patterns.

6. A memory system comprising:
a memory device configured to store first training information and second training information representing different training patterns; and
a memory controller configured to:
perform a first training operation on the memory device based on the first training information,
perform a verify operation of verifying a result of the first training operation when the result of the first training operation is out of a predetermined range, and
perform a second training operation on the memory device based on the first training information or the second training information according to a result of the verify operation.

7. The memory system of claim 6, wherein the memory controller performs the verify operation by re-performing the first training operation on the memory device based on the first training information and by checking whether a result of the re-performed first training operation is out of the predetermined range.

8. The memory system of claim 7, wherein the memory controller performs, when it is checked that the result of the first training operation is out of the predetermined range, according to the verify operation, the second training operation on the memory device based on the second training information.

9. The memory system of claim 8, wherein the memory controller performs the second training operation plural times.

10. The memory system of claim 9, wherein the memory controller is further configured to compute a final training value according to the second training operations performed the plural times.

11. The memory system of claim 7, wherein the memory controller performs, when it is checked that the result of the first training operation belongs within the predetermined range, according to the verify operation, the second training operation on the memory device based on the first training information.

12. A method of operating a memory system, the method comprising:
performing a first training operation on a memory device based on first training information stored in the memory device;
performing a second training operation plural times when a result of the first training operation is out of a predetermined range; and
computing a final training value according to the second training operations performed the plural times.

13. The method of claim 12, further comprising verifying the result of the first training operation when the result of the first training operation is out of the predetermined range.

14. The method of claim 13, wherein the verifying includes:
re-performing the first training operation on the memory device based on the first training Information; and
checking whether a result of the re-performed first training operation is out of the predetermined range.

15. The method of claim 14, wherein the second training operation is performed the plural times based on second training Information representing training patterns different from a training pattern of the first training information when the result of the re-performed first training operation is out of the predetermined range.

16. The method of claim 14, wherein the second training operation is performed the plural times based on the first training information when the result of the re-performed first training operation is included in the predetermined range.

17. The method of claim 12, wherein the computing includes accumulating results of the second training operations performed the plural times.
